(19) United States
(12) Patent Application Publication
(10) Pub. No.: US 2025/0036797 A1
(43) Pub. Date: Jan. 30, 2025

(54) Detection Method and Apparatus for Privacy Information Leakage and Electronic Device

(71) Applicant: Hillstone Networks Co., Ltd., Suzhou, Jiangsu (CN)

(72) Inventors: Wenyue LI, Suzhou, Jiangsu (CN); Yisheng HE, Suzhou, Jiangsu (CN); Wangjunjie ZHANG, Suzhou, Jiangsu (CN); Jun XU, Suzhou, Jiangsu (CN); Zhenghan WANG, Suzhou, Jiangsu (CN)

(21) Appl. No.: 17/785,932

(22) PCT Filed: Apr. 21, 2022
(86) PCT No.: PCT/CN2022/088147

§ 371 Date: Jun. 16, 2022

(51) Int. Cl. G06F 21/62; G06F 21/55

(52) U.S. Cl. CPC G06F 21/6245; G06F 21/556

(57) ABSTRACT

Provided are a detection method and apparatus for privacy information leakage and an electronic device. The detection method for privacy information leakage includes: acquiring an application to be detected, and performing reverse parsing on the application to obtain a parsed target file; performing static analysis on the target file to obtain a dynamic loading path and a target privacy protocol of the application; generating a first detection result according to the target privacy protocol and a preset protocol; detecting, according to the dynamic loading path, user privacy information used by the application in a dynamic loading process to generate a second detection result; and determining, according to the first detection result and the second detection result, whether the application is an abnormal application causing leakage of the user privacy information.

### TECHNICAL FIELD

The disclosure relates to the field of information security, in particular to a detection method and apparatus for privacy information leakage and an electronic device.

### BACKGROUND

Android applications are booming rapidly as the mobile internet technology keeps growing. When android applications acquire various user data, plenty of software development kits (SDKs) will accordingly be used and acquire a great deal of user data.

With the increasing attention of users on personal privacy data, relevant laws and regulations have been made at home and abroad to protect user privacy data. With this background, how to detect whether an android application complies with relevant regulations when using user privacy information is of vital significance to the supervision department and the enterprise launching the android application.

However, in the related art, for detecting whether an application acquires user privacy information legally, the android application is analyzed and detected only while software development kits associated with the android application are ignored. Therefore, detection accuracy of detecting whether an application acquires user privacy information legally is poor in the related art.

No effective solution has been proposed yet at present to solve the problems.

### SUMMARY

The disclosure provides a detection method and apparatus for privacy information leakage and an electronic device, so as to at least solve the technical problem that detection accuracy of detecting whether an application acquires user privacy information legally is poor in the related art.

One aspect of the disclosure provides a detection method for privacy information leakage. The method includes: acquiring an application to be detected, and performing reverse parsing on the application to obtain a parsed target file; performing static analysis on the target file to obtain a dynamic loading path and a target privacy protocol of the application, wherein the target privacy protocol at least comprises a first privacy protocol of the application and a second privacy protocol of a software development kit associated with the application, and the dynamic loading path is a control flow path achieving dynamic loading; generating a first detection result according to the target privacy protocol and a preset protocol, wherein the first detection result indicates whether the application is an application illegally using user privacy information when not running, and the preset protocol is a protocol to determine whether the target privacy protocol meets preset specifications; detecting, according to the dynamic loading path, the user privacy information used by the application in a dynamic loading process to generate a second detection result, wherein the second detection result indicates whether the application is an application illegally using the user privacy information when running; and determining, according to the first detection result and the second detection result, whether the application is an abnormal application causing leakage of the user privacy information.

Optionally, the detection method for privacy information leakage further includes: detecting whether a code in the target file is subjected to packing, wherein the packing comprises at least one of the following processing methods: encrypting the code, hiding the code and obfuscating the code; performing unpacking on the code to obtain an original code not subjected to the packing when the code is subjected to the packing, wherein the unpacking is reverse processing of the packing; and determining the dynamic loading path and the target privacy protocol of the application according to the original code.

Optionally, the detection method for privacy information leakage further includes: extracting the first privacy protocol of the application and mark information of the software development kit according to the original code; acquiring the second privacy protocol of the software development kit according to the mark information; and using semantic analysis to analyze the first privacy protocol and the second privacy protocol, and integrating analysis results to obtain the target privacy protocol.

Optionally, the detection method for privacy information leakage further includes: determining that the application is an application illegally using the user privacy information when not running, under the condition that content of the target privacy protocol does not match content of the preset protocol; acquiring a first code in the target file when the content of the target privacy protocol matches the content of the preset protocol, wherein the first code indicates user privacy information to be actually acquired by the application; and determining whether the application is an application illegally using the user privacy information when not running, according to the first code and the target privacy protocol.

Optionally, the detection method for privacy information leakage further includes: parsing the first code to obtain the user privacy information to be actually acquired by the application; determining that the application is an application legally using the user privacy information when not running, under the condition that the user privacy information to be actually acquired by the application matches the content of the target privacy protocol; and determining that the application is an application illegally using the user privacy information when not running, under the condition that the user privacy information to be actually acquired by the application does not match the content of the target privacy protocol.

Optionally, the detection method for privacy information leakage further includes: inserting a second code for recording dynamic loading information in the application; generating an input event for triggering a dynamic loading process of the application according to the dynamic loading path; triggering a dynamic loading process of the application by the input event, and acquiring, by the second code, all information loaded by the application in the dynamic loading process; and using data flow analysis to track a transmission process of the user privacy information in all the information on the dynamic loading path, and generating the second detection result according to a tracking result.

Optionally, the detection method for privacy information leakage further includes: performing the data flow analysis from an entry point of the dynamic loading path, and identifying the user privacy information from all the information; marking the identified user privacy information to obtain mark data; performing taint propagation on the mark data; acquiring target dynamic loading information recorded by the second code at the target node, when it is detected that the application performs dynamic loading call at a target node on the dynamic loading path; and tracking the mark data between the dynamic loading path and an external code according to the target dynamic loading information to obtain the tracking result.

Optionally, the detection method for privacy information leakage further includes: determining that the application is an application legally using the user privacy information when running, under the condition that a transmission process matches the target privacy protocol, wherein the transmission process is a process of the mark data between the dynamic loading path and the external code; and determining that the application is an application illegally using the user privacy information when running, under the condition that the transmission process of the mark data between the dynamic loading path and the external code does not match the target privacy protocol.

Optionally, the detection method for privacy information leakage further includes: determining that the application is a normal application not causing leakage of the user privacy information, under the conditions that the first detection result indicates that the application is an application legally using the user privacy information when not running, and the second detection result indicates that the application is an application legally using the user privacy information when running; and determining that the application is an abnormal application causing leakage of the user privacy information, under the conditions that the first detection result indicates that the application is an application illegally using the user privacy information when not running, or the second detection result indicates that the application is an application illegally using the user privacy information when running.

Another aspect of the disclosure further provides a detection apparatus for privacy information leakage. The apparatus includes: an acquisition module configured to acquire an application to be detected, and to perform reverse parsing on the application to obtain a parsed target file; a static analysis module configured to perform static analysis on the target file to obtain a dynamic loading path and a target privacy protocol of the application, wherein the target privacy protocol at least comprises a first privacy protocol of the application and a second privacy protocol of a software development kit associated with the application, and the dynamic loading path is a control flow path achieving dynamic loading; a first detection module configured to generate a first detection result according to the target privacy protocol and a preset protocol, wherein the first detection result indicates whether the application is an application illegally using user privacy information when not running, and the preset protocol is a protocol to determine whether the target privacy protocol meets preset specifications; a second detection module configured to detect, according to the dynamic loading path, the user privacy information used by the application in a dynamic loading process to generate a second detection result, wherein the second detection result indicates whether the application is an application illegally using the user privacy information when running; and a determination module configured to determine, according to the first detection result and the second detection result, whether the application is an abnormal application causing leakage of the user privacy information.

Another aspect of the disclosure further provides a computer-readable storage medium storing a computer program, where the computer program is configured to execute the above detection method for privacy information leakage when running.

Another aspect of the disclosure further provides an electronic device, which includes one or more processors; and a storage device for storing one or more programs, where when the one or more programs are executed by the one or more processors, the one or more processors are used for running a program, and the program is configured to execute the above detection method for privacy information leakage when running.

In the disclosure, the method of performing static detection on the application according to the target privacy protocol and the preset protocol, and performing dynamic detection on the application according to the dynamic loading path is used. After the application to be detected is acquired, and the reverse parsing is performed on the application to obtain the parsed target file, the static analysis is performed on the target file to obtain the dynamic loading path and the target privacy protocol of the application. Then the first detection result is generated according to the target privacy protocol and the preset protocol, and according to the dynamic loading path, the user privacy information used by the application in the dynamic loading process is detected to generate the second detection result. Finally, according to the first detection result and the second detection result, whether the application is an abnormal application causing leakage of the user privacy information is determined. The target privacy protocol at least includes the first privacy protocol of the application and the second privacy protocol of the software development kit associated with the application. The dynamic loading path is the control flow path achieving dynamic loading. The first detection result indicates whether the application is an application illegally using the user privacy information when not running. The preset protocol is a protocol to determine whether the target privacy protocol meets preset specifications. The second detection result indicates whether the application is an application illegally using the user privacy information when running.

It can be seen from the above content that, in the disclosure, the target privacy protocol includes the first privacy protocol of the application, and further includes the second privacy protocol of the software development kit associated with the application. Therefore, compared with the related art in which only an application is detected, the disclosure has the following effect that when the application is subjected to the static detection according to the target privacy protocol and the preset protocol, the application is detected, and the software development kit associated with the application is also detected, thereby improving detection comprehensiveness of the user privacy information. In addition, in the disclosure, the user privacy information used by the application in the dynamic loading process is detected according to the dynamic loading path, such that leakage of the user privacy information caused by the dynamic loading of the application is also detected. On this basis, whether the application is an abnormal application is comprehensively determined on the basis of the first detection result and the second detection result. In fact, a final detection result is obtained after a static detection result and a dynamic detection result of the application are comprehensively analyzed, thereby improving detection accuracy of the user privacy information.

It can be seen that by means of the technical solution of the disclosure, a process that the application uses the user privacy information is comprehensively detected, so as to prevent the user privacy information from being leaked by the application, and further solve the technical problem that detection accuracy of detecting whether an application acquires user privacy information legally is poor in the related art.

### BRIEF DESCRIPTION OF THE DRAWINGS

The accompanying drawings described herein serve to provide a further understanding of the disclosure and form a part hereof, and the illustrative embodiments of the disclosure and the description of the illustrative embodiments serve to explain the disclosure and are not to be construed as unduly limiting the disclosure. In the accompanying drawings:

FIG. 1 is a flowchart of a detection method for privacy information leakage according to an embodiment of the disclosure;

FIG. 2 is a flowchart of performing static analysis on an application to be detected according to an embodiment of the disclosure;

FIG. 3 is a flowchart of performing static analysis on an application to be detected according to an embodiment of the disclosure;

FIG. 4 is a flowchart of performing static analysis on an application to be detected according to an embodiment of the disclosure;

FIG. 5 is a flowchart of performing dynamic analysis on an application to be detected according to an embodiment of the disclosure; and

FIG. 6 is a schematic diagram of an optional detection apparatus for privacy information leakage according to an embodiment of the disclosure.

### DETAILED DESCRIPTION OF THE EMBODIMENTS

In order to enable those skilled in the art to better understand the solutions of the disclosure, the technical solutions in the embodiments of the disclosure will be described below clearly and comprehensively in conjunction with the accompanying drawings in the embodiments of the disclosure. Apparently, the embodiments described are merely some of rather than all embodiments. On the basis of the embodiments of the disclosure, all other embodiments obtained by those of ordinary skill in the art without making inventive efforts should all fall within the protection scope of the disclosure.

It should be noted that the terms “first”, “second” and so forth, in the description and claims of the disclosure and in the above-mentioned accompanying drawings, are used to distinguish between similar objects and not necessarily to describe a particular order or sequential order. It should be understood that data used in this way can be interchanged under appropriate circumstances, such that the embodiments of the disclosure described herein may be implemented in a sequence other than those illustrated or described herein. Moreover, the terms “include” and “have” as well as any variations thereof are intended to mean covered and non-exclusive inclusion, for example, a process, a method, a system, a product or an apparatus including a series of steps or units is not required to be limited by those explicitly listed, but may include other steps or units not explicitly listed or inherent to the process, method, product or apparatus.

In addition, it should be noted that the relevant information (including but not limited to user equipment information, user personal information, etc.) and data (including but not limited to data for display, data for analysis, etc.) involved in the disclosure are all information and data authorized by a user or fully authorized by all parties. For example, an interface is provided between the system and a relevant user or institution, and before relevant information is acquired, an acquisition request is required to be sent to the user or institution by means of the interface, and the relevant information is acquired after the consent information fed back by the user or institution is received.

### Embodiment 1

According to the embodiments of the disclosure, an embodiment of a detection method for privacy information leakage is provided. It should be noted that steps illustrated in the flowchart of the accompanying drawings may be implemented in a computer system such as a set of computer-executable instructions, and although a logical order is illustrated in the flowchart, under some conditions, the steps shown or described may be implemented in an order different from that herein.

In addition, it should be noted that an electronic device may serve as an implementation body of the detection method for privacy information leakage in the embodiment of the disclosure, where the electronic device may be a server, a notebook computer, a desktop computer, a smart tablet, a smart phone, and other devices.

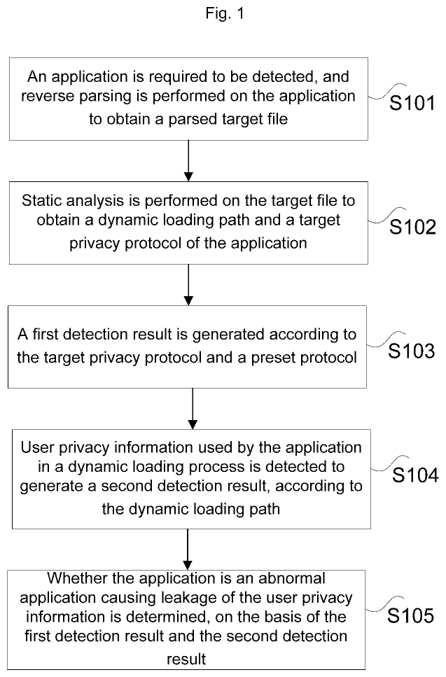

FIG. 1 is a flowchart of a detection method for privacy information leakage according to an embodiment of the disclosure. As shown in FIG. 1, the method includes steps as follows.

Step S101, acquire an application to be detected, and perform reverse parsing on the application to obtain a parsed target file.

In step S101, the application to be detected is an android application, and a process of performing reverse parsing on the application may be a process in which an electronic device uses an android analysis tool, such as, an APKtool (an application compilation tool) to unpack an android application package (APK) to be detected so as to obtain the target file. The target file at least includes information of a source code and a configuration file of the application to be detected, and specifically includes: the configuration file, a bytecode file, an application interface, an icon and other resource files.

Step S102, perform static analysis on the target file to obtain a dynamic loading path and a target privacy protocol of the application.

In step S102, the target privacy protocol at least includes a first privacy protocol of the application and a second privacy protocol of a software development kit associated with the application, and the dynamic loading path is a control flow path achieving dynamic loading. The software development kit (SDK) is associated with the application.

In addition, the electronic device may acquire the first privacy protocol of the application according to a code in the target file and may further acquire mark information of the software development kit, then uses technologies such as search engine search, automatic crawling and page content parsing to collect the second privacy protocol of the software development kit according to the mark information, and finally integrates the first privacy protocol and the second privacy protocol to obtain the target privacy protocol.

It should be noted that, in actual application scenarios, the reason why an application is removed due to illegal use of user privacy data may not be that a code of the application does not meet regulations, but may be that a software development kit used does not meet regulations. Therefore, in the disclosure, by integrating the second privacy protocol of the software development kit and the first privacy protocol of the application, it is ensured that the software development kit is detected while the application is detected, thereby improving detection comprehensiveness of the application. In addition, in the related art, the software development kit is generally manually detected, so as to consume a large amount of manpower. However, in the disclosure, regulatory compliance of the software development kit and the application is automatically detected, thereby reducing manpower cost and improving detection efficiency.

Step S103, generate a first detection result according to the target privacy protocol and a preset protocol.

In step S103, the first detection result indicates whether the application is an application illegally using user privacy information when not running, and the preset protocol is a protocol to determine whether the target privacy protocol meets preset specifications. The preset protocol is relevant laws and regulations formulated by a supervision organization according to the user privacy information. Specifically, an operator compiles the preset protocol according to content of the relevant laws and regulations, and stores the preset protocol so as to be conveniently called by the electronic device at any time. Under the condition that content of the target privacy protocol does not match content of the preset protocol, the electronic device determines that the application is an application illegally using the user privacy information when not running. For example, if the content in the target privacy protocol is beyond the content specified in the preset protocol (that is, the relevant laws and regulations), the electronic device determines that the application is an application illegally using the user privacy information. In addition, under the condition that the content of the target privacy protocol matches the content of the preset protocol, the electronic device is further required to detect whether user privacy data to be actually acquired by the application complies with the target privacy protocol, if yes, it is determined that the application is an application legally using the user privacy information when not running, if not, it is still required to determine that the application is an application illegally using the user privacy information when not running.

By means of the above process, in the disclosure, whether the first privacy protocol and the second privacy protocol comply with the relevant laws and regulations will be detected first, and then after it is determined that the first privacy protocol and the second privacy protocol all meet the relevant laws and regulations, whether the user privacy data to be actually acquired by the application meets the target privacy protocol is detected. It can be seen therefrom that, compared with the related art in which only an application is detected, the disclosure has the effects that more comprehensive static detection is performed on the android application and the software development kit.

Step S104, detect, according to the dynamic loading path, user privacy information used by the application in a dynamic loading process to generate a second detection result.

In step S104, the second detection result indicates whether the application is an application illegally using the user privacy information when running. A process according to the dynamic loading path at least includes: analyze static information (that is, the target file) to determine the dynamic loading path; generate, according to the static information, an input event for triggering a dynamic loading process of the application; perform instrumentation on the application to be detected to implant a second code for saving dynamic loading information; trigger the dynamic loading process of the application by means of the input event; and use data flow analysis to track, according to the acquired dynamic loading information and path information, a transmission process of the user privacy information in the dynamic loading process, and obtain a second detection result on the basis of a tracking result.

It should be noted that the user privacy information refers to data information that may uniquely identify a personal identity of a user, such as an international mobile equipment identity (IMEI) number of equipment used by the user, an international mobile subscriber identity (IMSI) number, a mobile phone number, etc., and personal data used by the user, such as, geographic position information and an application list, etc. In the disclosure, according to the dynamic loading path, the user privacy information used by the application in the dynamic loading process is detected, so as to detect leakage of the user privacy information of the application caused by the dynamic loading, thereby preventing the user privacy data from being leaked when the application performs the dynamic loading.

Step S105, determine, according to the first detection result and the second detection result, whether the application is an abnormal application causing leakage of the user privacy information.

In step S105, under the conditions that the first detection result indicates that the application is an application legally using the user privacy information when not running, and the second detection result indicates that the application is an application legally using the user privacy information when running, the electronic device determines that the application is a normal application not causing leakage of the user privacy information. Under the condition that the first detection result indicates that the application is an application illegally using the user privacy information when not running, or the second detection result indicates that the application is an application illegally using the user privacy information when running, the electronic device determines that the application is an abnormal application causing leakage of the user privacy information.

By means of the above process, in the disclosure, a final detection result is obtained by means of a static detection result and a dynamic detection result of the application are comprehensively analyzed, so as to comprehensively detect regulatory compliance of the application when not running and when running, thereby improving detection accuracy of the user privacy information.

It can be seen from content of step S101 to step S105 that in the embodiment of the disclosure, a method of performing static detection on the application according to the target privacy protocol and the preset protocol, and performing dynamic detection on the application according to the dynamic loading path is used. After the application to be detected is acquired, and the reverse parsing is performed on the application to obtain the parsed target file, the static analysis is performed on the target file to obtain the dynamic loading path and the target privacy protocol of the application. Then the first detection result is generated according to the target privacy protocol and the preset protocol, and according to the dynamic loading path, the user privacy information used by the application in the dynamic loading process is detected to generate the second detection result. Finally, according to the first detection result and the second detection result, whether the application is an abnormal application causing leakage of the user privacy information is determined. The target privacy protocol at least includes the first privacy protocol of the application and the second privacy protocol of the software development kit associated with the application. The dynamic loading path is the control flow path achieving dynamic loading. The first detection result indicates whether the application is an application illegally using the user privacy information when not running. The preset protocol is a protocol to determine whether the target privacy protocol meets preset specifications. The second detection result indicates whether the application is an application illegally using the user privacy information when running.

It can be seen from the above content that, in the disclosure, the target privacy protocol includes the first privacy protocol of the application, and further includes the second privacy protocol of the software development kit associated with the application. Therefore, compared with the related art in which only an application is detected, the disclosure has the following effect that when the application is subjected to the static detection according to the target privacy protocol and the preset protocol, the application is detected, and the software development kit associated with the application is also detected, thereby improving detection comprehensiveness of the user privacy information. In addition, in the disclosure, the user privacy information used by the application in the dynamic loading process is detected according to the dynamic loading path, such that leakage of the user privacy information caused by the dynamic loading of the application is also detected. On this basis, whether the application is an abnormal application is comprehensively determined on the basis of the first detection result and the second detection result. In fact, a final detection result is obtained after a static detection result and a dynamic detection result of the application are comprehensively analyzed, thereby improving detection accuracy of the user privacy information.

It can be seen that by means of the technical solution of the disclosure, a process that the application uses the user privacy information is comprehensively detected, so as to prevent the user privacy information from being leaked by the application, and further solve the technical problem that detection accuracy of detecting whether an application acquires user privacy information legally is poor in the related art.

In one optional embodiment, after acquiring the target file, the electronic device detects whether a code in the target file is subjected to packing. When the code is subjected to the packing, the electronic device performs unpacking on the code to obtain an original code not subjected to the packing. Finally, the electronic device determines the dynamic loading path and the target privacy protocol of the application according to the original code. The packing includes at least one of the following processing methods: encrypt the code, hide the code and obfuscate the code. The unpacking is reverse processing of the packing.

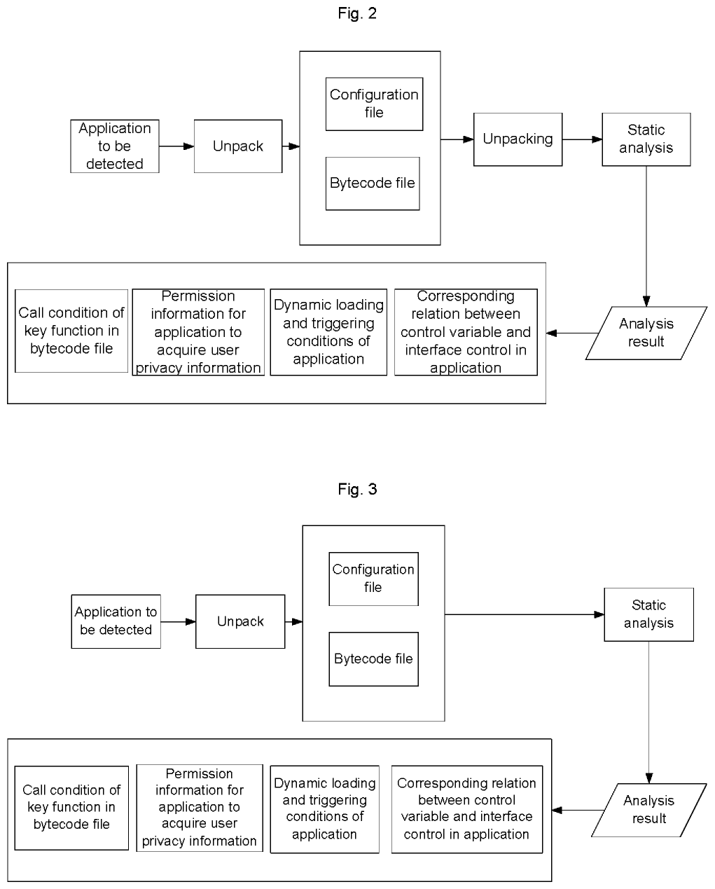

Optionally, in the related art, packing is performed on some android applications, and for the android applications subjected to the packing, SDKs associated therewith may not be queried. Therefore, in order to ensure that relevant information of the SDKs may be acquired, unpacking is required to be performed on the applications subjected to the packing. As shown in FIG. 2, the electronic device first performs out reverse parsing such as unpacking on an android application to obtain a target file, where the target file at least includes: a configuration file and a bytecode file. Then, the electronic device detects whether a code in the target file is subjected to packing, if yes, unpacking is performed on the android application. Next, static analysis is performed on an original code subjected to the unpacking, for example, a call condition of a key function in the bytecode file is analyzed, permission information for the application to acquire user privacy information is analyzed, dynamic loading and triggering conditions of the application are analyzed, a corresponding relation between a control variable and interface control in the application is analyzed, and whether the application acquires positioning information of user equipment, IMEI, IMSI and other information is analyzed.

Optionally, as shown in FIG. 3, if the electronic device detects that a code in a target file corresponding to an android application is not subjected to the packing, the electronic device is not required to perform unpacking on the target file, and may directly perform static analysis on the code in the target file.

What may be easily noted is that in the disclosure, by identifying whether the packing is performed on the application to be detected and by performing the unpacking on the application subjected to the packing, the problem that information of the software development kit associated with the application may not be acquired due to the packing of the application is solved.

In one optional embodiment, the electronic device first extracts the first privacy protocol of the application and mark information of the software development kit according to the original code, then acquires the second privacy protocol of the software development kit according to the mark information, and finally uses semantic analysis to analyze the first privacy protocol and the second privacy protocol, and integrates analysis results to obtain the target privacy protocol.

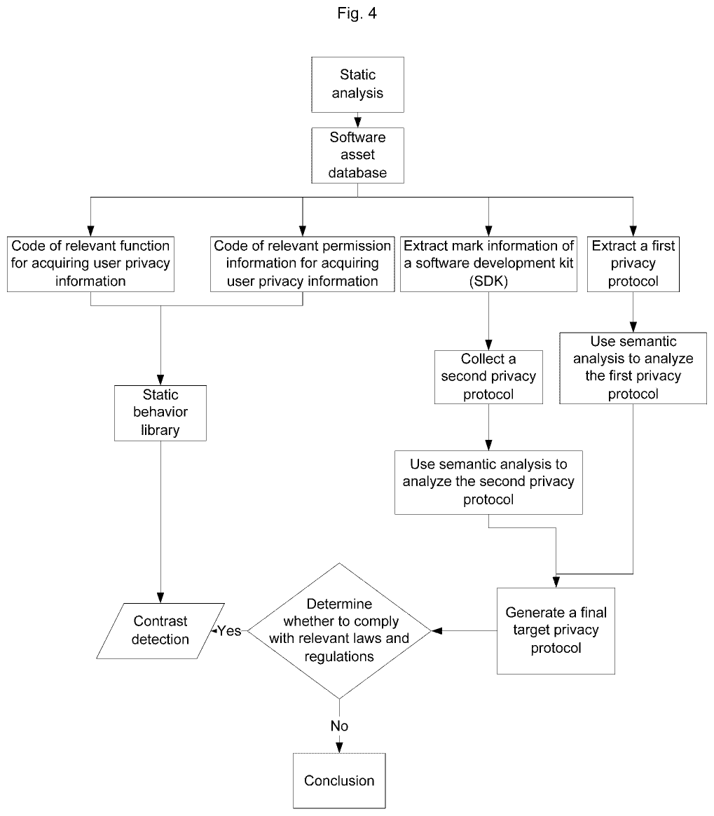

Optionally, as shown in FIG. 4, after the electronic device completes performing the static analysis on the application to be detected, the analysis result is stored in a form of a software asset database, and then the electronic device may directly acquire the required information from the software asset database. The electronic device may extract the first privacy protocol of the application to be detected on the basis of the original code, and use the semantic analysis to analyze the first privacy protocol to obtain a first analysis result. Moreover, the electronic device may further extract the mark information of the SDK associated with the application on the basis of the original code and acquire developer information of the SDK and developer website information according to the mark information and matching rules given by the SDK, then use technologies such as a search engine, automatic crawling and page content parsing to collect the second privacy protocol of the SDK, and finally use the semantic analysis to analyze the second privacy protocol to obtain a second analysis result. The electronic device integrates the first analysis result and the second analysis result to generate a final target privacy protocol, and the target privacy protocol may be understood as regulatory compliance behavior rules of use of privacy information corresponding to the application to be detected and the SDK associated therewith.

In one optional embodiment, after the target privacy protocol is generated, the electronic device is required to detect whether the target privacy protocol meets the relevant laws and regulations. Specifically, under the condition that the content of the target privacy protocol does not match the content of the preset protocol, the electronic device determines that the application is an application illegally using the user privacy information when not running. For example, as shown in FIG. 4, the operator makes the preset protocol according to content of the relevant laws and regulations. When the content of the target privacy protocol does not match the content of the preset protocol, it is indicated that the content of the target privacy protocol does not meet the relevant laws and regulations. In this case, the electronic device determines that the application is an application illegally using the user privacy information when not running.

Moreover, when the content of the target privacy protocol matches the content of the preset protocol, the electronic device acquires a first code in the target file, where the first code indicates the user privacy information to be actually acquired by the application. Then, the electronic device determines, according to the first code and the target privacy protocol, whether the application is an application illegally using the user privacy information when not running. Specifically, the electronic device parses the first code to obtain the user privacy information to be actually acquired by the application. Then, under the condition that the user privacy information to be actually acquired by the application matches the content of the target privacy protocol, the electronic device determines that the application is an application legally using the user privacy information when not running. Under the condition that the user privacy information to be actually acquired by the application does not match the content of the target privacy protocol, the electronic device determines that the application is an application illegally using the user privacy information when not running.

Optionally, as shown in FIG. 4, after the target privacy protocol meets the relevant laws and regulations, the electronic device is further required to detect whether the user privacy information to be actually acquired by the application meets regulations of the target privacy protocol. Specifically, the electronic device first acquires the first code for indicating the user privacy information to be actually acquired by the application, such as, a code for indicating a relevant function for acquiring the user privacy information and a code for indicating relevant permission information for acquiring the user privacy information. The electronic device parses the first code and stores a parsing result in a static behavior library. Then, the electronic device performs contrast detection on the user privacy information to be actually acquired by the application and the content of the target privacy protocol, if the two do not match, for example, the content of the target privacy protocol does not specify acquisition of a bank card number of a user, but the application actually is required to acquire the bank card number of the user. In this case, the electronic device determines that the application is an application illegally using the user privacy information when not running. Under the condition that the user privacy information to be actually acquired by the application matches the content of the target privacy protocol, the electronic device determines that the application is an application legally using the user privacy information when not running.

Optionally, the following table shows an example of using a target privacy protocol to perform static detection on an application:

| | Requirements of laws | |
|---|---|---|
| Data processing flow | and regulations | Detection content |
| Data collection | Whether notification is fully | Whether a privacy protocol |
| | given before data collection | including an SDK is provided |
| | | and may be easily acquired |
| Data use and | Ensure that data processing is | Whether collected information |
| processing | consistent with the objective of | and requested permission are |
| | data initial collection | consistent with privacy statement |
| | Ensure that data processing | Whether collected information |
| | follows the principles of | and requested permission are |
| | accuracy, necessity and | consistent with/relevant to a |
| | timeliness, and take relevance | functional objective realized by |
| | and necessity as limits | a program or is necessary for |
| | | realization of a main function |
| | | of the program |
| Data storage | Whether specific protection | Whether transmission of user |
| Data transmission | measures are taken to ensure | privacy information is |
| | data security for data storage | encrypted/whether local storage |
| | and transmission of a data | meet standards |
| | subject | |
| Third-party data | Whether a third-party data | Whether a third-party data |
| processing | processor may ensure rights of | processor sends data back or |
| | a data subject and whether | sends information that a client |
| | processing measures thereof | application may not verify to |
| | comply with laws | a fourth party |

In one optional embodiment, the electronic device further detects, according to the dynamic loading path, user privacy information used by the application in a dynamic loading process to generate a second detection result. Specifically, the electronic device first inserts a second code for recording dynamic loading information in the application, then generates, according to the dynamic loading path, an input event for triggering a dynamic loading process of the application, triggers a dynamic loading process of the application by the input event, and acquires, by means of the second code, all information loaded by the application in the dynamic loading process. Finally, the electronic device uses data flow analysis to track a transmission process of the user privacy information in all the information on the dynamic loading path, and generates the second detection result according to a tracking result.

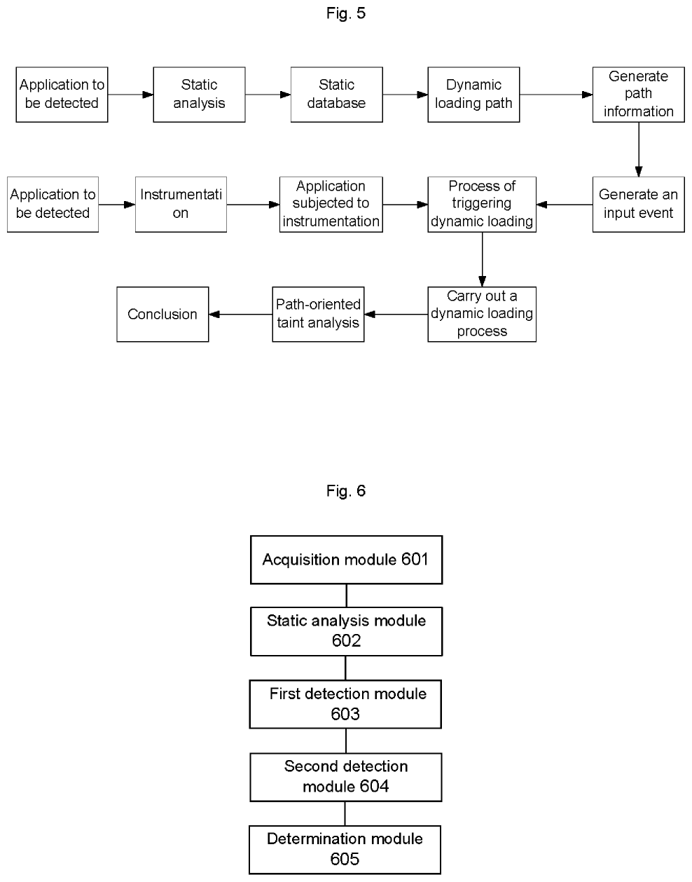

Optionally, as shown in FIG. 5, after the electronic device performs static analysis on the application to be detected and stores an analysis result of the static analysis in a static database (that is, the software asset database), the electronic device first extracts static information from the static database, then determines a dynamic loading path of the application to be detected on the basis of the static information, and generates path information. Then, the electronic device generates, according to the path information, an input event for triggering the dynamic loading process of the application.

In addition, before the input event is generated, the electronic device may use Soot to perform instrumentation on the application to be detected. Soot is used for analysis, instrumentation and optimization of an android application. Firstly, according to a node of dynamic loading determined by a generation process of path information, corresponding positions of the application required to be subjected to the instrumentation are found. Then, Soot is used to perform the instrumentation on these corresponding positions. The instrumentation is to insert the second code for recording dynamic loading information into the application. In addition, since a plurality of program statements are generally required to complete a call process of dynamic loading, which includes file load, class load and method call, a second code for saving the dynamic loading information may be inserted behind each statement. For example, since there is external file path information when a DexClassLoader statement is created, a second code for saving a loaded file may be inserted behind the DexClassLoader statement. After the instrumentation is completed, the electronic device may start to trigger the dynamic loading process of the application by means of the input event.

It should be noted that, although by directly executing the input event on the application to be detected, the dynamic loading may be triggered, in order to comprehensively detect a dynamically loaded external code, the dynamically loaded external code, a called class, a method and other basic information are required to be acquired in the dynamic loading process, so as to complete comprehensive detection. It can be seen that in the disclosure, the instrumentation is used to implant the second code into the application to be detected, such that relevant information in the dynamic loading process is saved when the application runs, and further information such as code segments and corresponding content passed in the whole dynamic loading process is saved. On this basis, the electronic device may generate the second detection result by analyzing a transmission process of the user privacy information in the information on the dynamic loading path.

In one optional embodiment, the electronic device may use data flow analysis to track the transmission process of the user privacy information in all the information on the dynamic loading path. Specifically, the electronic device performs the data flow analysis from an entry point of the dynamic loading path, identifies the user privacy information from all the information, then marks the identified user privacy information to obtain mark data, and performs taint propagation on the mark data. When it is detected that the application performs dynamic loading call at the target node on the dynamic loading path, the electronic device acquires target dynamic loading information recorded by the second code at a target node, and then tracks the mark data between the dynamic loading path and an external code according to the target dynamic loading information to obtain the tracking result.

Optionally, as shown in FIG. 5, the disclosure provides a path-oriented taint analysis method. Specifically, an electronic device analyzes each dynamic loading path, and detects whether there is a behavior of illegally transmitting user privacy information on each dynamic loading path. Firstly, for a path which may achieve dynamic loading call, data flow analysis is performed on a control flow path P from an entrance thereof, when it is found that a key sensitive function (for example, a function for acquiring the user privacy information such as a device number, a mobile phone number) is called, the user privacy information acquired thereby is marked by means of taints to obtain mark data, and the mark data is tracked on a subsequent path. Then, if it is found that there is the dynamic loading call at a certain target node on the path, target dynamic loading information recorded by a second code at a target node is acquired. Finally, the mark data between the dynamic loading path and an external code may be tracked by means of the target dynamic loading information to obtain a tracking result.

In one optional embodiment, a tracking process may include the following processes: track whether taint data (that is, mark data) is transmitted to an external code by means of a parameter of dynamic loading call and is leaked by the external code; check whether the external code acquires the taint data, and track a transmission process of the taint data in the external code; and check whether the external code acquires the taint data, and track whether the taint data has a return value, if yes, continue to track the return value on the path P, and detect whether the return value will be transmitted.

In one optional embodiment, under the condition that a transmission process of the mark data between the dynamic loading path and the external code matches the target privacy protocol, the electronic device determines that the application is an application legally using the user privacy information when running. Under the condition that the transmission process of the mark data between the dynamic loading path and the external code does not match the target privacy protocol, the electronic device determines that the application is an application illegally using the user privacy information when running.

Optionally, the electronic device may acquire the transmission process of the mark data between the dynamic loading path and the external code according to the tracking result. On this basis, the electronic device determines whether the application is an application illegally using the user privacy information when running by detecting whether the transmission process complies with specified content of the target privacy protocol. For example, if the target privacy protocol specifies that an application to be detected may not transmit a mobile phone number of a user to an external code, but the tracking result shows that the application to be detected transmits the mobile phone number of the user to the external code, then the electronic device determines that the application is an application illegally using the user privacy information when running.

In one optional embodiment, under the condition that the first detection result indicates that the application is an application legally using the user privacy information when not running, and the second detection result indicates that the application is an application legally using the user privacy information when running, the electronic device determines that the application is a normal application not causing leakage of the user privacy information. Under the condition that the first detection result indicates that the application is an application illegally using the user privacy information when not running, or the second detection result indicates that the application is an application illegally using the user privacy information when running, the electronic device determines that the application is an abnormal application causing leakage of the user privacy information.

It can be seen from the above content that, in the disclosure, whether the application is an abnormal application is comprehensively determined according to the first detection result and the second detection result. In fact, a final detection result is obtained after a static detection result and a dynamic detection result of the application are comprehensively analyzed, thereby improving detection accuracy of the user privacy information.

### Embodiment 2

According to the embodiments of the disclosure, an embodiment of a detection apparatus for privacy information leakage is further provided. FIG. 6 is a schematic diagram of an optional detection apparatus for privacy information leakage according to the embodiment of the disclosure. As shown in FIG. 6, the detection apparatus includes: an acquisition module 601, a static analysis module 602, a first detection module 603, a second detection module 604 and a determination module 605.

The acquisition module 601 is configured to acquire an application to be detected, and to perform reverse parsing on the application to obtain a parsed target file. The static analysis module 602 is configured to perform static analysis on the target file to obtain a dynamic loading path and a target privacy protocol of the application, wherein the target privacy protocol at least comprises a first privacy protocol of the application and a second privacy protocol of a software development kit associated with the application, and the dynamic loading path is a control flow path achieving dynamic loading. The first detection module 603 is configured to generate a first detection result according to the target privacy protocol and a preset protocol, wherein the first detection result indicates whether the application is an application illegally using user privacy information when not running, and the preset protocol is a protocol to determine whether the target privacy protocol meets preset specifications. The second detection module 604 is configured to detect, according to the dynamic loading path, the user privacy information used by the application in a dynamic loading process to generate a second detection result, wherein the second detection result indicates whether the application is an application illegally using the user privacy information when running. The determination module 605 is configured to determine, according to the first detection result and the second detection result, whether the application is an abnormal application causing leakage of the user privacy information.

Optionally, the above static analysis module further includes: a third detection module, an unpacking module and a first determination module. The third detection module is configured to detect whether a code in the target file is subjected to packing, where the packing includes at least one of the following processing methods: encrypting the code, hiding the code and obfuscating the code. The unpacking module is configured to perform unpacking on the code to obtain an original code not subjected to the packing when the code is subjected to the packing, where the unpacking is reverse processing of the packing. The first determination module is configured to determine the dynamic loading path and the target privacy protocol of the application according to the original code.

Optionally, the above first determination module further includes: an extraction module, a first acquisition module and an analysis module. The extraction module is configured to extract the first privacy protocol of the application and mark information of the software development kit according to the original code. The first acquisition module is configured to acquire the second privacy protocol of the software development kit according to the mark information. The analysis module is configured to use semantic analysis to analyze the first privacy protocol and the second privacy protocol, and integrate analysis results to obtain the target privacy protocol.

Optionally, the further first detection module further includes: a second determination module, a second acquisition module and a third determination module. The second determination module is configured to determine that the application is an application illegally using the user privacy information when not running, under the condition that content of the target privacy protocol does not match content of the preset protocol. The second acquisition module is configured to acquire a first code in the target file when the content of the target privacy protocol matches the content of the preset protocol, where the first code indicates user privacy information to be actually acquired by the application. The third determination module is configured to determine whether the application is an application illegally using the user privacy information when not running, according to the first code and the target privacy protocol.

Optionally, the above third determination module further includes: a parsing module, a fourth determination module and a fifth determination module. The parsing module is configured to parse the first code to obtain the user privacy information to be actually acquired by the application. The fourth determination module is configured to determine that the application is an application legally using the user privacy information when not running, under the condition that the user privacy information to be actually acquired by the application matches the content of the target privacy protocol. The fifth determination module is configured to determine that the application is an application illegally using the user privacy information when not running, under the condition that the user privacy information to be actually acquired by the application does not match the content of the target privacy protocol.

Optionally, the above second detection module further includes: a recording module, a generation module, a second acquisition module and a tracking module. The recording module is configured to insert a second code for recording dynamic loading information in the application. The generation module is configured to generate an input event for triggering a dynamic loading process of the application according to the dynamic loading path. The second acquisition module is configured to trigger a dynamic loading process of the application by the input event, and acquire, by the second code, all information loaded by the application in the dynamic loading process. The tracking module is configured to use data flow analysis to track a transmission process of the user privacy information in all the information on the dynamic loading path, and generate the second detection result according to a tracking result.

Optionally, the above tracking module further includes: an identification module, a marking module, a propagation module, a third acquisition module and a first tracking module. The identification module is configured to perform the data flow analysis from an entry point of the dynamic loading path, and identify the user privacy information from all the information. The marking module is configured to mark the identified user privacy information to obtain mark data. The propagation module is configured to perform taint propagation on the mark data. The third acquisition module is configured to acquire target dynamic loading information recorded by the second code at the target node, when it is detected that the application performs dynamic loading call at a target node on the dynamic loading path. The first tracking module is configured to track the mark data between the dynamic loading path and an external code according to the target dynamic loading information to obtain the tracking result.

Optionally, the above tracking module further includes: a sixth determination module and a seventh determination module. The sixth determination module is configured to determine that the application is an application legally using the user privacy information when running, under the condition that a transmission process of the mark data between the dynamic loading path and the external code matches the target privacy protocol. The seventh determination module is configured to determine that the application is an application illegally using the user privacy information when running, under the condition that the transmission process of the mark data between the dynamic loading path and the external code does not match the target privacy protocol.

Optionally, the above determination module further includes: an eighth determination module and a ninth determination module. The eighth determination module is configured to determine that the application is a normal application not causing leakage of the user privacy information, under the conditions that the first detection result indicates that the application is an application legally using the user privacy information when not running, and the second detection result indicates that the application is an application legally using the user privacy information when running. The ninth determination module is configured to determine that the application is an abnormal application causing leakage of the user privacy information, under the condition that the first detection result indicates that the application is an application illegally using the user privacy information when not running, or the second detection result indicates that the application is an application illegally using the user privacy information when running.

### Embodiment 3

Another aspect of the embodiments of the disclosure further provides a computer-readable storage medium storing a computer program, where the computer program is configured to execute the above detection method for privacy information leakage in Embodiment 1 when running.

### Embodiment 4

Another aspect of the embodiments of the disclosure further provides an electronic device, which includes one or more processors; and a storage device for storing one or more programs, where when the one or more programs are executed by the one or more processors, the one or more processors are used for running a program, and the program is configured to execute the above detection method for privacy information leakage in Embodiment 1 when running.

The serial number of the above embodiments of the disclosure is only used for description and does not represent the merits of the embodiments.

In the above embodiments of the disclosure, the descriptions of various embodiments are emphasized on their respective aspects, and for portions of a certain embodiment that are not described in detail, reference may be made to the associated descriptions of other embodiments.

In several embodiments provided in the disclosure, it should be understood that the disclosed technology may be implemented in other ways. The apparatus embodiment described above is merely illustrative, for example, division of units may be division of logical functions, and in practice there may be additional ways of division, for example, a plurality of units or assemblies may be combined or integrated into another system, or some features may be ignored or not implemented. As another point, shown or discussed coupling or direct coupling or communication connection between each other may be an indirect coupling or communication connection by means of some interfaces, units or modules, and may be in an electrical or other form.

The units illustrated as separate components may be physically separate or not, and the components shown as units may be physical units or not, that is, may be located in one place, or may also be distributed over a plurality of units. Part or all of the units may be selected according to actual requirements to achieve the objective of the solutions of the embodiments.

In addition, each functional unit in each embodiment of the disclosure may be integrated in one processing unit, or each unit may exist separately and physically, or two or more units may be integrated in one unit. The above integrated units may be implemented in a hardware form and may also be implemented in a form of a software functional unit.

The integrated unit may be stored in a computer-readable storage medium if implemented in the form of a software functional unit and sold or used as an independent product. On the basis of the understanding, the technical solutions of the disclosure may be embodied in the form of a software product in essence or a part contributing to the related art or all or part of the technical solutions, and the computer software product is stored in a storage medium and includes several instructions for enabling a computer device (which may be a personal computer, a server or a network device, etc.) to execute all or part of the steps of the methods described in the various embodiments of the disclosure. The foregoing storage medium may be a universal serial bus flash disk, a read-only memory (ROM), a random access memory (RAM), a mobile hard disk, a magnetic disk, an optical disk and other media capable of storing program codes.

What is mentioned above is merely preferred embodiments of the disclosure, and it should be noted that several improvements and modifications may also be made by those of ordinary skill in the art without departing from the principles of the disclosure, which should also be considered to fall within the scope of protection of the disclosure.

### INDUSTRIAL APPLICABILITY

The solutions provided in the embodiments of the disclosure can be applied in the technical field of information security. In the embodiments of the disclosure, when the application is subjected to static detection according to the target privacy protocol and the preset protocol, the application is detected, and the software development kit associated with the application is also detected, thereby improving detection comprehensiveness of the user privacy information. In addition, in the disclosure, the user privacy information used by the application in the dynamic loading process is detected according to the dynamic loading path, such that leakage of the user privacy information caused by the dynamic loading of the application is also detected. On this basis, whether the application is an abnormal application is comprehensively determined on the basis of the first detection result and the second detection result. In fact, a final detection result is obtained after a static detection result and a dynamic detection result of the application are comprehensively analyzed, thereby improving detection accuracy of the user privacy information.

1. A detection method for privacy information leakage, comprising:
acquiring an application to be detected, and performing reverse parsing on the application to obtain a parsed target file;
performing static analysis on the target file to obtain a dynamic loading path and a target privacy protocol of the application, wherein the target privacy protocol at least comprises a first privacy protocol of the application and a second privacy protocol of a software development kit associated with the application, and the dynamic loading path is a control flow path achieving dynamic loading;
generating a first detection result according to the target privacy protocol and a preset protocol, wherein the first detection result indicates whether the application is an application illegally using user privacy information when not running, and the preset protocol is a protocol to determine whether the target privacy protocol meets preset specifications;
detecting, according to the dynamic loading path, the user privacy information used by the application in a dynamic loading process to generate a second detection result, wherein the second detection result indicates whether the application is an application illegally using the user privacy information when running; and
determining, according to the first detection result and the second detection result, whether the application is an abnormal application causing leakage of the user privacy information.

2. The method as claimed in claim 1, wherein the performing static analysis on the target file to obtain a dynamic loading path and a target privacy protocol of the application comprises:
detecting whether a code in the target file is subjected to packing, wherein the packing comprises at least one of the following processing methods: encrypting the code, hiding the code and obfuscating the code;
performing unpacking on the code to obtain an original code not subjected to the packing when the code is subjected to the packing, wherein the unpacking is reverse processing of the packing; and
determining the dynamic loading path and the target privacy protocol of the application according to the original code.

3. The method as claimed in claim 2, wherein the determining the target privacy protocol of the application according to the original code comprises:
extracting the first privacy protocol of the application and mark information of the software development kit according to the original code;
acquiring the second privacy protocol of the software development kit according to the mark information; and
using semantic analysis to analyze the first privacy protocol and the second privacy protocol, and integrating analysis results to obtain the target privacy protocol.

4. The method as claimed in claim 1, wherein the generating a first detection result according to the target privacy protocol and a preset protocol comprises:
determining that the application is an application illegally using the user privacy information when not running, under the condition that content of the target privacy protocol does not match content of the preset protocol;
acquiring a first code in the target file when the content of the target privacy protocol matches the content of the preset protocol, wherein the first code indicates user privacy information to be actually acquired by the application; and
determining whether the application is an application illegally using the user privacy information when not running, according to the first code and the target privacy protocol.

5. The method as claimed in claim 4, wherein the determining whether the application is an application illegally using the user privacy information when not running, according to the first code and the target privacy protocol comprises:
parsing the first code to obtain the user privacy information to be actually acquired by the application;
determining that the application is an application legally using the user privacy information when not running, under the condition that the user privacy information to be actually acquired by the application matches the content of the target privacy protocol; and
determining that the application is an application illegally using the user privacy information when not running, under the condition that the user privacy information to be actually acquired by the application does not match the content of the target privacy protocol.

6. The method as claimed in claim 1, wherein the detecting, according to the dynamic loading path, the user privacy information used by the application in a dynamic loading process to generate a second detection result, comprises:
inserting a second code for recording dynamic loading information in the application;
generating an input event for triggering a dynamic loading process of the application according to the dynamic loading path;
triggering a dynamic loading process of the application by the input event, and acquiring, by the second code, all information loaded by the application in the dynamic loading process; and
using data flow analysis to track a transmission process of the user privacy information in all the information on the dynamic loading path, and generating the second detection result according to a tracking result.

7. The method as claimed in claim 6, wherein the using data flow analysis to track a transmission process of the user privacy information in all the information on the dynamic loading path comprises:
performing the data flow analysis from an entry point of the dynamic loading path, and identifying the user privacy information from all the information;
marking the identified user privacy information to obtain mark data;
performing taint propagation on the mark data;
acquiring target dynamic loading information recorded by the second code at the target node, when it is detected that the application performs dynamic loading call at a target node on the dynamic loading path; and
tracking the mark data between the dynamic loading path and an external code according to the target dynamic loading information to obtain the tracking result.

8. The method as claimed in claim 7, wherein generating the second detection result according to a tracking result comprises:
determining that the application is an application legally using the user privacy information when running, under the condition that a transmission process matches the target privacy protocol, wherein the transmission process is a process of the mark data between the dynamic loading path and the external code; and
determining that the application is an application illegally using the user privacy information when running, under the condition that the transmission process of the mark data between the dynamic loading path and the external code does not match the target privacy protocol.

9. The method as claimed in claim 1, wherein the determining, according to the first detection result and the second detection result, whether the application is an abnormal application causing leakage of the user privacy information comprises:
determining that the application is a normal application not causing leakage of the user privacy information, under the conditions that the first detection result indicates that the application is an application legally using the user privacy information when not running, and the second detection result indicates that the application is an application legally using the user privacy information when running; and
determining that the application is an abnormal application causing leakage of the user privacy information, under the conditions that the first detection result indicates that the application is an application illegally using the user privacy information when not running, or the second detection result indicates that the application is an application illegally using the user privacy information when running.

10. A detection apparatus for privacy information leakage, comprising:
an acquisition module configured to acquire an application to be detected, and to perform reverse parsing on the application to obtain a parsed target file;
a static analysis module configured to perform static analysis on the target file to obtain a dynamic loading path and a target privacy protocol of the application, wherein the target privacy protocol at least comprises a first privacy protocol of the application and a second privacy protocol of a software development kit associated with the application, and the dynamic loading path is a control flow path achieving dynamic loading;
a first detection module configured to generate a first detection result according to the target privacy protocol and a preset protocol, wherein the first detection result indicates whether the application is an application illegally using user privacy information when not running, and the preset protocol is a protocol to determine whether the target privacy protocol meets preset specifications;
a second detection module configured to detect, according to the dynamic loading path, the user privacy information used by the application in a dynamic loading process to generate a second detection result, wherein the second detection result indicates whether the application is an application illegally using the user privacy information when running; and
a determination module configured to determine, according to the first detection result and the second detection result, whether the application is an abnormal application causing leakage of the user privacy information.

11. (canceled)

12. An electronic device, comprising one or more processors; and a storage device for storing one or more programs, wherein when the one or more programs are executed by the one or more processors, the one or more processors are used for running a program, and the program is configured to execute the detection method for privacy information leakage of claim 1 when running.

13. The method as claimed in claim 2, wherein the method further comprises:
performing static analysis on the code in the target file, when the code in the target file corresponding to an android application is not subjected to the packing.

14. The method as claimed in claim 3, wherein the acquiring the second privacy protocol of the software development kit according to the mark information comprises:
acquiring developer information of the software development kit and developer website information according to the mark information and matching rules given by the software development kit; and
collecting the second privacy protocol of the software development kit by using a search engine, automatic crawling or page content parsing.

15. The method as claimed in claim 1, wherein the performing static analysis on the target file to obtain a dynamic loading path comprises:
extracting static information from the static database, after performing static analysis on the application to be detected and storing an analysis result of the static analysis in a static database;
determining the dynamic loading path of the application to be detected according to the static information, and generating path information.

16. The method as claimed in claim 15, wherein method further comprises:
generating an input event for triggering the dynamic loading process of the application according to the path information.

17. The method as claimed in claim 6, wherein the inserting a second code for recording dynamic loading information in the application comprises:
determining positions of the application required to be subjected to the instrumentation, according to a node of dynamic loading determined by a generation process of path information;
performing instrumentation on the positions, wherein the instrumentation is to insert the second code for recording dynamic loading information into the application.

18. The method as claimed in claim 17, wherein the method further comprises:
inserting the second code for saving the dynamic loading information behind each statement of a call process of dynamic loading.

19. The method as claimed in claim 7, wherein the tracking process comprises the following processes:
tracking whether taint data is transmitted to an external code by means of a parameter of dynamic loading call and is leaked by the external code;
checking whether the external code acquires the taint data, and tracking a transmission process of the taint data in the external code;
and checking whether the external code acquires the taint data, and tracking whether the taint data has a return value, if yes, tracking the return value on the path, and detecting whether the return value will be transmitted.

20. The method as claimed in claim 4, wherein the first code is a code for indicating a relevant function for acquiring the user privacy information and a code for indicating relevant permission information for acquiring the user privacy information.

21. The method as claimed in claim 7, wherein the method further comprises:
requiring the dynamically loaded external code, a called class, a method and other basic information in the dynamic loading process.
